(19) United States
(12) Patent Application Publication
(10) Pub. No.: US 2015/0170384 A1
(43) Pub. Date: Jun. 18, 2015

(54) APPARATUS AND METHOD FOR CREATING DRAWING DATA SUPERIMPOSING GROUPED DATA ON A SCREEN

(71) Applicant: FUJITSU LIMITED, Kawasaki-shi (JP)

(72) Inventors: Keita MATSUMOTO, Yokohama (JP); Seigo Ishino, Kawasaki (JP)

(21) Appl. No.: 14/559,182

(22) Filed: Dec. 3, 2014

(30) Foreign Application Priority Data
Dec. 13, 2013 (JP) 2013-258540

(51) Int. Cl. G06T 11/20; G06T 11/60

(52) U.S. Cl. CPC G06T 11/206; G06T 11/60

(57) ABSTRACT

Upon detecting, on a screen that displays first drawing data including two or three category series of first grouped data each associated with different one of categories of the first grouped data, a superimposing operation for superimposing the two or three category series of first grouped data, an apparatus calculates representative values for each of one or two category series of second grouped data that are generated by superimposing at least one category series of first grouped data in accordance with the superimposing operation. The apparatus creates second drawing data including the representative values that are calculated for each of the one or two category series of second grouped data, and displays the second drawing data on the screen.

### CROSS-REFERENCE TO RELATED APPLICATION

This application is based upon and claims the benefit of priority of the prior Japanese Patent Application No. 2013-258540, filed on Dec. 13, 2013, the entire contents of which are incorporated herein by reference.

### FIELD

The embodiments discussed herein are related to apparatus and method for creating drawing data superimposing grouped data on a screen.

### BACKGROUND

Graphs make it possible to visually represent tendencies indicated by data sets. For example, when a data set indicating the amounts of annual precipitation in prefectures is accumulated, it becomes easier to recognize a relative relationship of the amounts of precipitation classified by prefecture and year, by displaying the data set in a three-dimensional graph in which the names of the prefectures are allocated to an x-axis, years are allocated to a y-axis, and the amounts of precipitation are allocated to a z-axis.

Related art is disclosed in, for example, Japanese Laid-open Patent Publication No. 2013-88876 and International Publication Pamphlet No. 2013/021888.

In the three-dimensional graph described above, however, it is difficult to visually recognize a representative value of the amounts of precipitation in a plurality of years by prefecture or a representative value of the amounts of precipitation in a plurality of prefectures by year. That is, in order to recognize a representative value of the amounts of precipitation in a plurality of years by prefecture, the representative value is determined based on the amounts of precipitation in the respective years by prefecture. Also, in order to recognize a representative value of the amounts of precipitation in a plurality of prefectures by year, the representative values are determined based on the amounts of precipitation in the prefectures by year.

Thus, knowing a representative value of each data set classified according to a property different from classifications in a displayed drawing, such as a graph, involves a complicated intellectual work of a user of the drawing.

### SUMMARY

According to an aspect of the invention, an apparatus, upon detecting, on a screen that displays first drawing including two or three category series of first grouped data each associated with different one of categories of the first grouped data, a superimposing operation for superimposing the two or three category series of first grouped data, calculates representative values for each of one or two category series of second grouped data that are generated by superimposing at least one category series of first grouped data in accordance with the superimposing operation. The apparatus creates second drawing data including the representative values that are calculated for each of the one or two category series of second grouped data, and displays the second drawing data on the screen.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a functional configuration of an information processing apparatus, according to an embodiment;

FIGS. 2A and 2B are diagrams each illustrating an example of grouped data, according to an embodiment;

FIG. 3 is a diagram illustrating an example of an operational flowchart for graph creation processing, according to an embodiment;

FIG. 4 is a diagram illustrating an example of an operational flowchart for graph rendering processing, according to an embodiment;

FIG. 5 is a diagram illustrating an example of a displayed three-dimensional graph, according to an embodiment;

FIG. 6 is a diagram illustrating an example of an operational flowchart for triaxial rendering processing, according to an embodiment;

FIG. 7 is a diagram illustrating an example of an operational flowchart for 3D creation processing, according to an embodiment;

FIG. 8 is a diagram illustrating an example of an operational flowchart for 3D arrangement processing, according to an embodiment;

FIG. 9 is a diagram illustrating an example of an axis operation, according to an embodiment;

FIG. 10 is a diagram illustrating an example of an operation for manipulating a slider, according to an embodiment;

FIG. 11 is a diagram illustrating an example of axis operation, according to an embodiment;

FIG. 12 is a diagram illustrating an example of an operational flowchart for biaxial rendering processing (width-axis average values), according to an embodiment;

FIG. 13 is a diagram illustrating an example of a result of biaxial rendering processing, according to an embodiment;

FIG. 14 is a diagram illustrating an example of a result of biaxial rendering processing, according to an embodiment;

FIG. 15 is a diagram illustrating an example of an operational flowchart for biaxial rendering processing (depth-axis average values), according to an embodiment;

FIG. 16 is a diagram illustrating an example of an operational flowchart for uniaxial rendering processing, according to an embodiment;

FIG. 17 is a diagram illustrating an example of a result of uniaxial rendering processing, according to an embodiment; and

FIG. 18 is a diagram illustrating an example of a hardware configuration of an information processing apparatus, according to an embodiment.

### DESCRIPTION OF EMBODIMENTS

Embodiments of the present disclosure will be described below with reference to the accompanying drawings. Herein and in the accompanying drawings, elements having substantially the same functional configuration are denoted by the same reference numerals, and redundant descriptions are not given.

[Functional Configuration of Information Processing Apparatus]

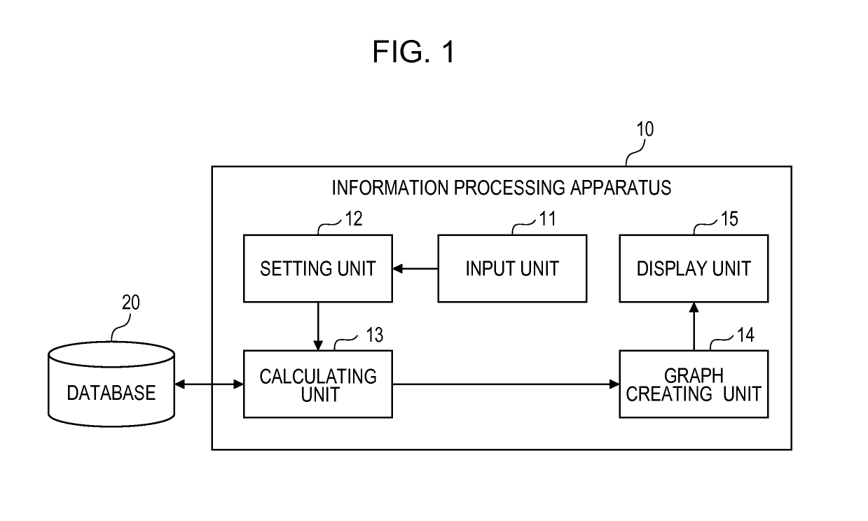

First, an example functional configuration of an information processing apparatus 10 according to one embodiment of the present disclosure will be described with reference to FIG. 1. FIG. 1 is a diagram illustrating an example of a functional configuration of an information processing apparatus, according to an embodiment.

The information processing apparatus 10 includes an interface for inputting a predetermined operation of a user to a drawing creation program and constructs, on a screen, a virtual three-dimensional coordinate system for rendering a stereoscopic graph. Examples of the information processing apparatus 10 include a personal computer (PC), a tablet-computer terminal, and a portable terminal, such as a smartphone. Examples of the graph rendered on the screen include a bar graph, a stacked bar graph, and a line graph.

The information processing apparatus 10 includes an input unit 11, a setting unit 12, a calculating unit 13, a graph creating unit 14, and a display unit 15. The input unit 11 inputs information corresponding to a user operation with a keyboard and/or a mouse.

The setting unit 12 sets parameters for creating a graph, in accordance with the user operation. Examples of the parameters include the type of graph and the scale of the graph and, when a bar graph is to be created, include the thickness of bars, colors of the bars, transparency settings, and translucency settings.

The calculating unit 13 classifies a data set, stored in a database 20, and calculates data (statistical values) to be displayed in the graph. For example, when a plurality of pieces of data having three categories “regional name”, “year”, and “temperature” are accumulated in the database 20, the calculating unit 13 may use the accumulated pieces of data to calculate the number of summer days on which the maximum temperature is 25° C. or more and the number of hot summer days on which the maximum temperature is 30° C. or more, by region and by year.

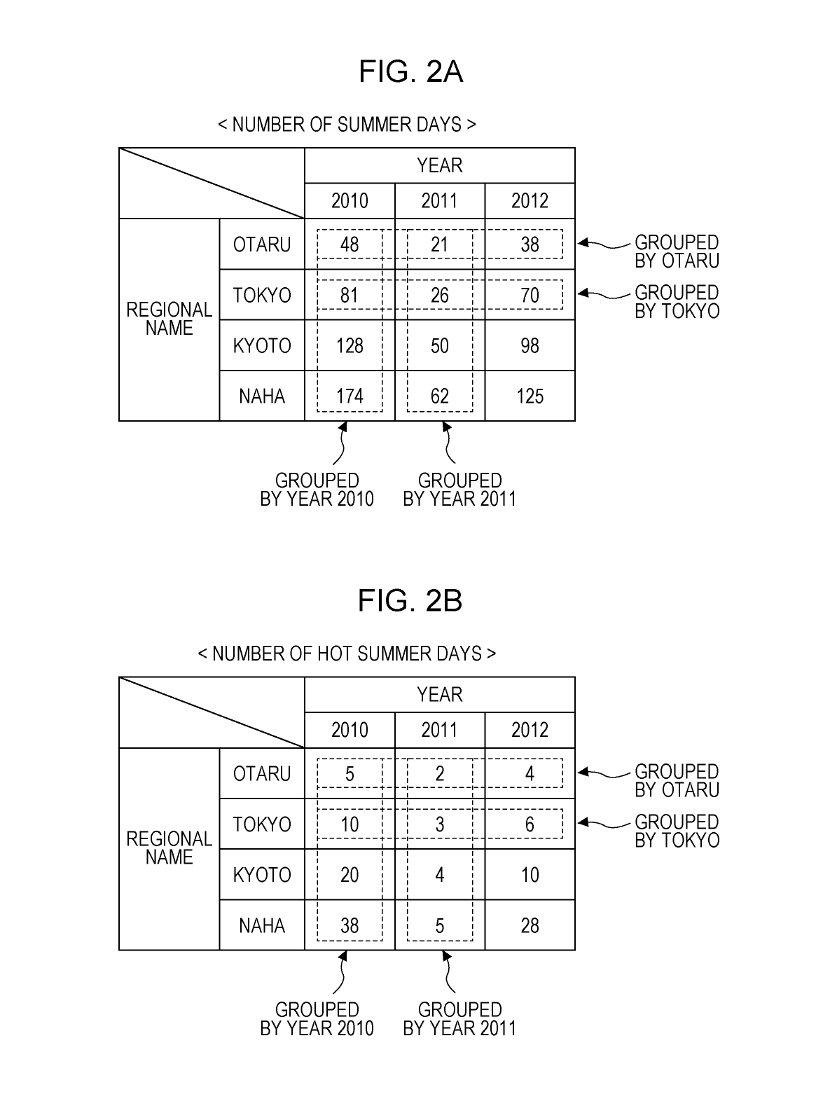

FIGS. 2A and 2B are diagrams each illustrating an example of grouped data, according to an embodiment. FIGS. 2A and 2B illustrate tables in which the data set accumulated in the database 20 is grouped by three pre-defined categories “regional name”, “year”, and number of days (temperature)“. More specifically, FIG. 2A is a table of data classified according to a combination of values “Otaru, Tokyo, Kyoto, and Naha” of “regional name”, values “2010, 2011, and 2012” of “year”, and values number of summer days” of number of days (temperature)”. The grouped data refers to data in which values of a certain category belong to the same group. For example, in FIG. 2A, data grouped by the category value “Otaru” are 48, 21, and 38, indicating the numbers of summer days in years 2010, 2011, and 2012, respectively. For example, data grouped by the category value “Tokyo” are 81, 26, and 70, indicating the numbers of summer days in years 2010, 2011, and 2012, respectively. As illustrated in FIGS. 2A and 2B, grouped data are, for example, classified by three category series of data that are each associated with different one of categories.

For example, in FIG. 2A, data grouped by the category value “year 2010” are 48, 81, 128, and 174, indicating the numbers of summer days in Otaru, Tokyo, Kyoto, and Naha, respectively. For example, data grouped by the category value “year 2011” are 21, 26, 50, and 62, indicating the numbers of summer days in Otaru, Tokyo, Kyoto, and Naha, respectively.

Similarly, for example, in FIG. 2B, data grouped by the category value “Otaru” are 5, 2, and 4, indicating the numbers of hot summer days in years 2010, 2011, and 2012, respectively.

The database 20 may be implemented using a storage device in the information processing apparatus 10 or a storage device connected to the information processing apparatus 10 through a network. One example of the storage device connected through a network is a storage device on a cloud computer.

The graph creating unit 14 creates, on a graph having a width axis, a depth axis, and a height axis, a three-dimensional graph indicating data calculated by the calculating unit 13. The display unit 15 displays the created graph on the screen. The graph creating unit 14 may also create a two-dimensional graph having either a width axis or a depth axis and a height axis. The graph creating unit 14 may also create a one-dimensional graph having a height axis. The graph creating unit 14 is an example of a drawing creating unit for creating a drawing in which representative values are displayed. Besides a three-dimensional graph and a two-dimensional graph, the drawing creating unit may also create a drawing in a tabular form (a table) like those illustrated in FIGS. 2A and 2B. That is, as another example, the drawing creating unit may create a table indicating representative values from a table like those illustrated in FIGS. 2A and 2B.

A three-dimensional graph in the embodiment is a two-dimensional image that visually represents a stereoscopic graph. Categories allocated to the width axis, depth axis, and height axis of the graph correspond to the categories (in FIGS. 2A and 2B) for grouping the data.

For example, “regional names” indicated on the width axis (x-axis), “number of days (temperature)” indicated on the height axis (y-axis), and “years” indicated on the depth axis (z-axis) are examples of the categories. Also, “Otaru”, “Tokyo”, “Kyoto”, and “Naha” are example values of the category “regional name”; number of summer days (25° C. or more)” and number of hot summer days (30° C. or more)” are example values of the category “number of days (temperature)”; and “2010”, “2011”, and “2012” are example values of the category “year”.

The description thus far has been given of an example functional configuration of the information processing apparatus 10 according to the embodiment. The description below will be given of graph creation processing executed by the information processing apparatus 10 having such a configuration.

[Graph Creation Processing]

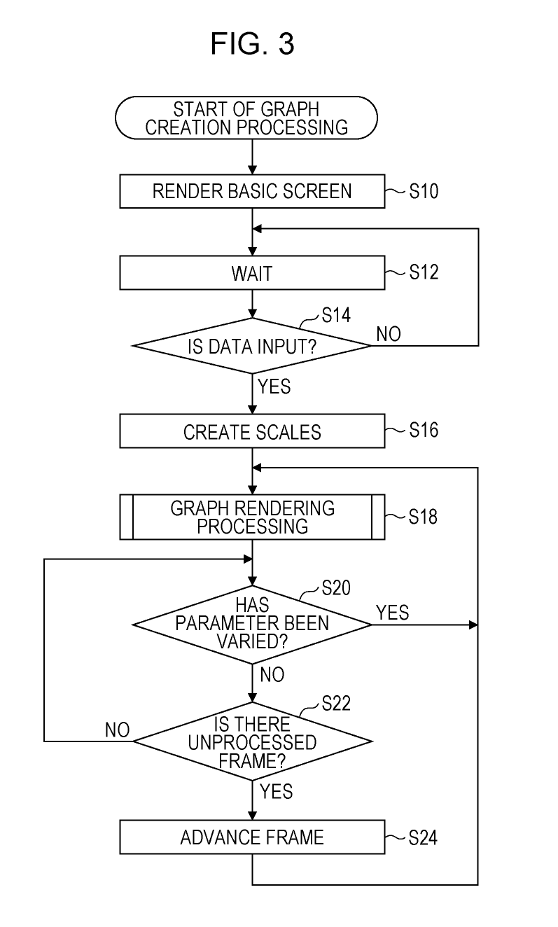

An example of graph creation processing according to the embodiment will now be described with reference to FIG. 3. FIG. 3 is a diagram illustrating an example of an operational flowchart for graph creation processing, according to an embodiment. Upon starting the graph creation processing, the graph creating unit 14 renders a basic screen (step S10). The graph creating unit 14 sets three axes, namely, a width axis, a depth axis, and a height axis, and renders a coordinate system for a virtual three-dimensional space for rendering a stereoscopic graph.

Next, the input unit 11 waits (step S12) until data is input (step S14). For example, an operation button for reading a file may be provided on a screen or an operation panel. In such a case, when the user presses the operation button, the input unit 11 determines that data is input, reads a data set of a specified file, and advances to step S16.

Next, the graph creating unit 14 creates scales of the axes of a graph (step S16). The graph creating unit 14 analyzes the distribution of the read data set, determines an optimum graph rendering range in accordance with the range of the distribution, and creates scales of the axes. This makes it possible to create a graph so that a maximum value and a minimum value in the data set optimally fit in the rendering space. In accordance with the created scales, the graph creating unit 14 creates scale marks on the axes and labels of categories allocated to the axes.

Next, the graph creating unit 14 executes graph rendering processing (step S18). In the graph rendering processing, the graph creating unit 14 executes processing for creating a graph to be rendered on the screen. Details of the graph rendering processing are described later.

After the graph is rendered on the screen, the setting unit 12 determines whether or not a parameter has been varied by a user operation (step S20). When it is determined that a parameter has been varied, the graph creating unit 14 executes the graph rendering processing again, based on the varied parameter (step S18). Through the processing described above, each time the user varies a parameter, the graph creating unit 14 creates a new graph and renders the created graph on the screen.

On the other hand, when it is determined that no parameter has been varied, the graph creating unit 14 determines that there is an unprocessed frame (step S22). The frame in this case refers to a video frame constituting one graph displayed as an animation. When it is determined in step S22 that there is no unprocessed frame, the process returns to step S20, and the setting unit 12 waits until a parameter is varied.

On the other hand, when it is determined that there is an unprocessed frame, the graph creating unit 14 advances the frame by one (step S24) and executes the graph rendering processing on a new (the next) frame (step S18). A graph for the frame is rendered on the screen. For example, when changes in temperature in individual regions in January to December are to be displayed as an animation, the graph creating unit 14 sequentially executes the processes in steps S18 to S24 on 12 frames. When the processes are executed, the display unit 15 sequentially displays, as an animation, graphs indicating the temperatures in the regions from January to December. In this case, when the graphs for January to December have been sequentially displayed, it is determined in step S22 that the result is “No”, the process returns to step S20, and the setting unit 12 waits until a parameter is varied.

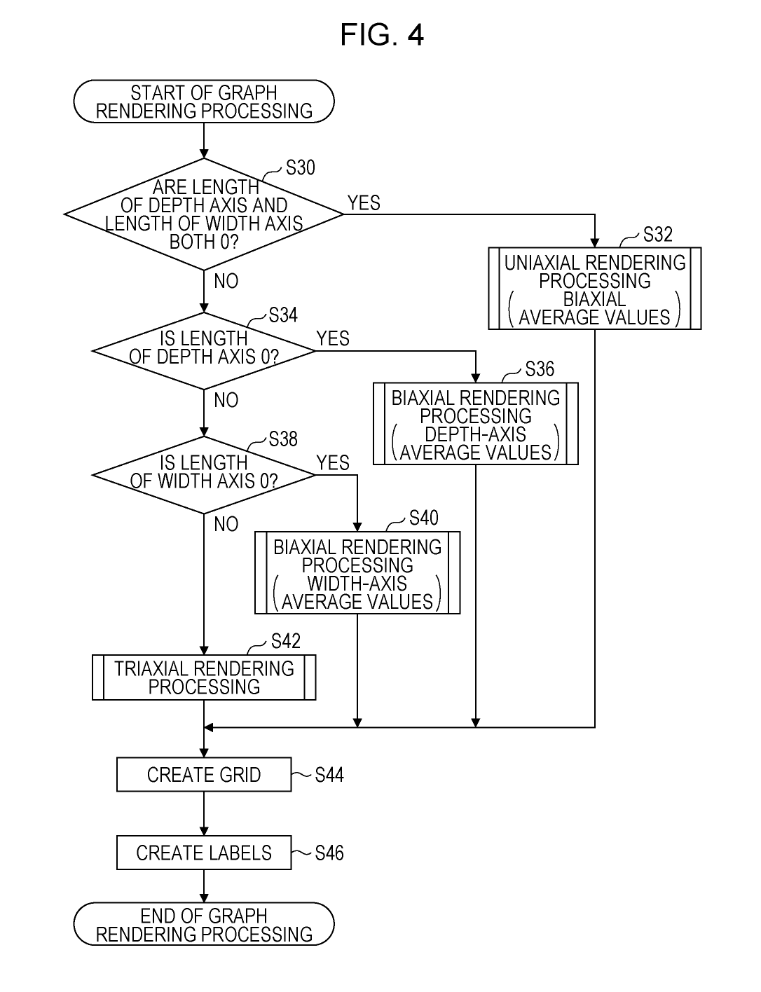

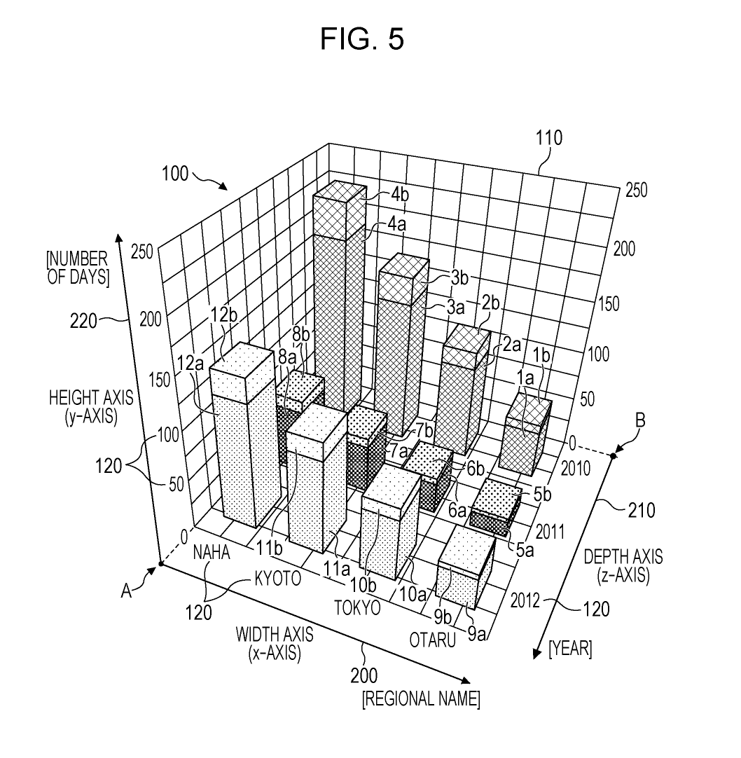

The description thus far has been given of the graph creation processing according to the embodiment. Next, the graph rendering processing called in step S18 in the graph creation processing will be described with reference to FIG. 4. In an example of a stacked bar graph 100 to be rendered in processing described below, three number lines x-axis, y-axis, and z-axis that are at right angles to one another are defined to render a three-dimensional graph, as illustrated in FIG. 5.

In this example, the width axis (x-axis) corresponds to the category “regional name”, the values of which are “Otaru”, “Tokyo”, “Kyoto”, and “Naha”. The height axis (y-axis) corresponds to the category “number of days” for the temperature, and the values of the category “number of days” are the number of summer days and the number of hot summer days. The “summer days” refers to days on which the maximum temperature is 25° C. or more, and the “hot summer days” refers to days on which the maximum temperature is 30° C. or more. The depth axis (z-axis) corresponds to the category “year”, the values of which are “2010”, “2011”, and “2012”.

[Graph Rendering Processing]

FIG. 4 is a diagram illustrating an example of an operational flowchart for graph rendering processing, according to an embodiment. When the graph rendering processing is started, the setting unit 12 determines whether or not an operation for setting the length of the depth axis at zero and an operation for setting the length of the width axis at zero have been detected (step S30). In this case, the user is able to variably manipulate each of the width axis, the depth axis, and the height axis displayed on the graph. The operations for setting the lengths of the axes at zero are described later.

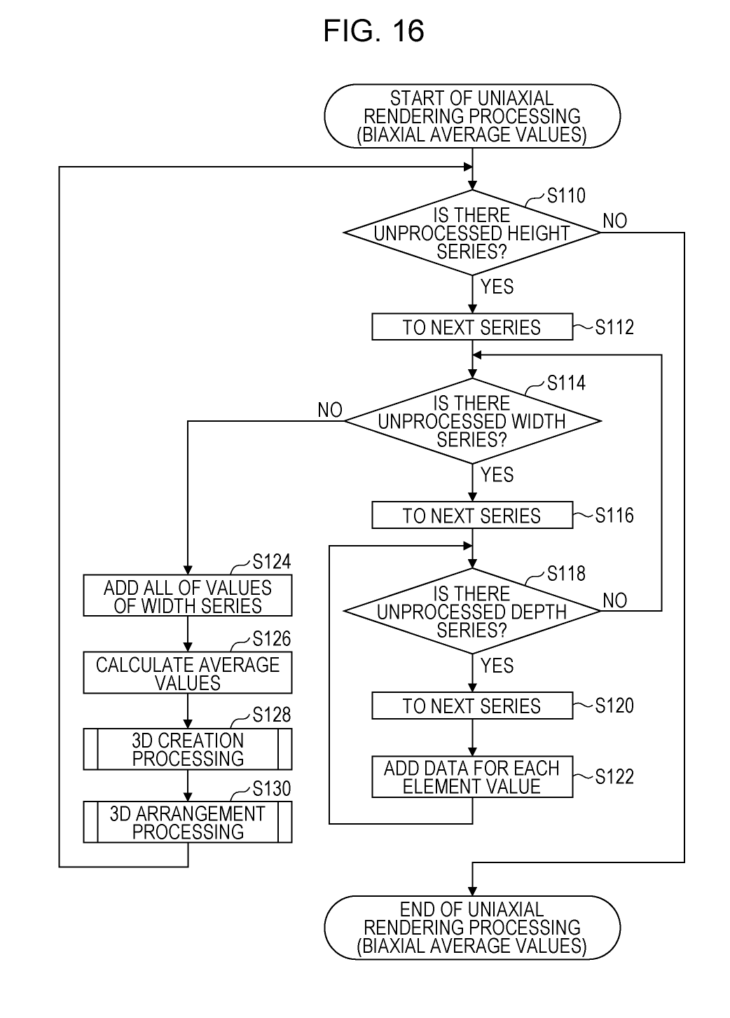

When it is determined that an operation for setting the length of the depth axis to 0 and an operation for setting the length of the width axis at zero have been detected, the graph creating unit 14 executes uniaxial rendering processing (biaxial average values) (step S32). The uniaxial rendering processing (FIG. 16) is described later.

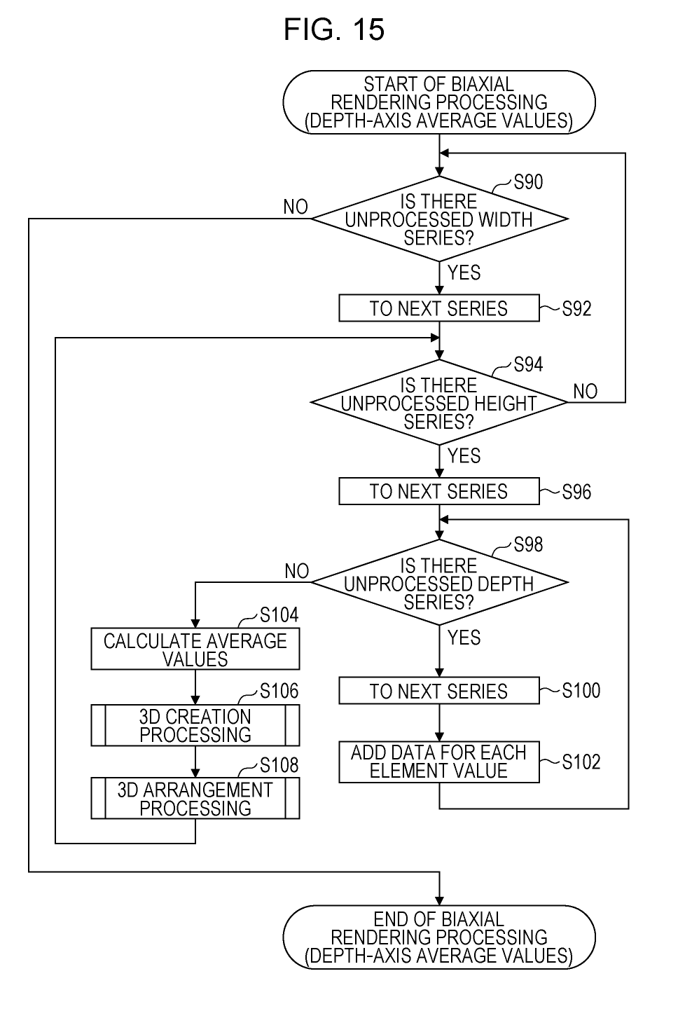

On the other hand, when it is determined that an operation for setting the length of the depth axis at zero and an operation for setting the length of the width axis at zero have not been detected, the setting unit 12 determines whether or not an operation for setting the length of the depth axis at zero has been detected (step S34). When it is determined that an operation for setting the length of the depth axis at zero has been detected, the graph creating unit 14 executes biaxial rendering processing (depth-axis average values) (step S36). The biaxial rendering processing (depth-axis average values) (FIG. 15) is described later.

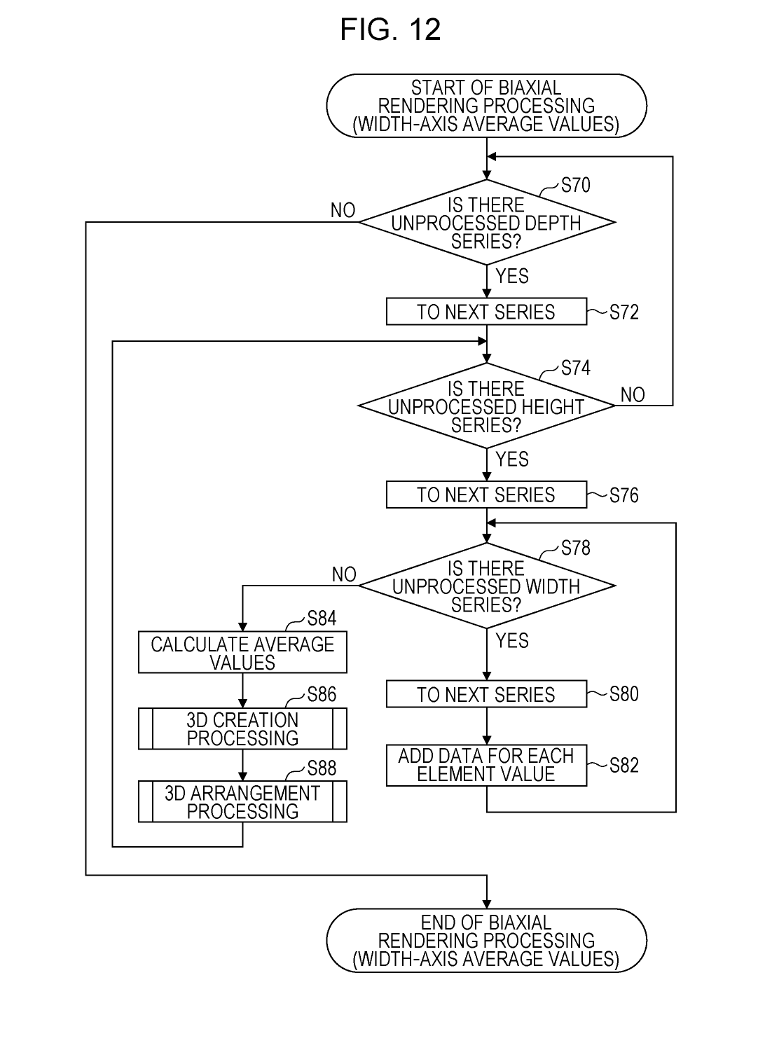

On the other hand, when it is determined that an operation for setting the length of the depth axis at zero has not been detected, the setting unit 12 determines whether or not an operation for setting the length of the width axis at zero has been detected (step S38). When it is determined that an operation for setting the length of the width axis at zero has been detected, the graph creating unit 14 executes the biaxial rendering processing (width-axis average values) (step S40). The biaxial rendering processing (width-axis average values) (FIG. 12) is described later.

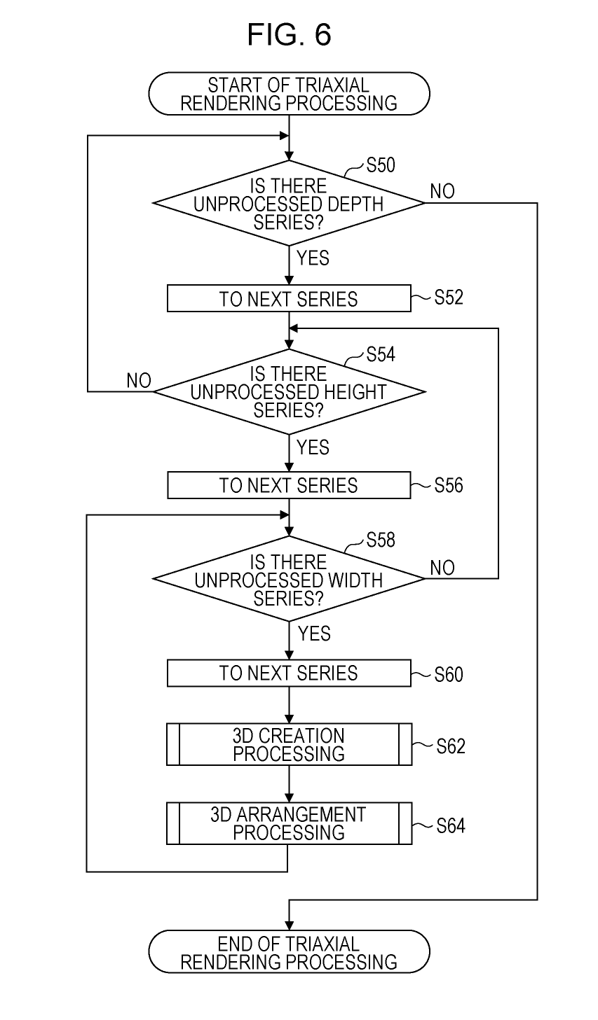

On the other hand, when it is determined that an operation for setting the length of the width axis at zero has not been detected, the graph creating unit 14 executes triaxial rendering processing (step S42). The triaxial rendering processing (FIG. 6) is described later.

The graph creating unit 14 creates a grid after executing the uniaxial rendering processing in step S32, the biaxial rendering processing (depth-axis average values) in step S36, the biaxial rendering processing (width-axis average values) in step S40, or the triaxial rendering processing in step S42 (step S44). As illustrated in FIG. 5, a grid 110 is a two-dimensional latticed image for helping the user recognize a three-dimensional space.

Referring back to FIG. 4, the graph creating unit 14 creates labels (step S46) and ends the graph rendering processing. The labels are indicators indicating the values on the axes. The graph in FIG. 5 has labels 120 for the regional names (Otaru, Tokyo, Kyoto, and Naha) on the width axis, labels 120 for the years (2010, 2011, and 2012) on the depth axis, and labels 120 for the number of days on the height axis.

The triaxial rendering processing in step S42, the biaxial rendering processing (width-axis average values) in step S40, the biaxial rendering processing (depth-axis average values) in step S36, and the uniaxial rendering processing (biaxial average values) in step S32 in the graph rendering processing described above will be described below in order. Hereinafter, an operation for setting the length of each axis at zero will be also expressed as “a superimposing operation”.

[Triaxial Rendering Processing]

An example of the triaxial rendering processing called in step S42 in FIG. 4 will now be described with reference to FIG. 6. FIG. 6 is a diagram illustrating an example of an operational flowchart for triaxial rendering processing, according to an embodiment.

In this case, for example, by using the database 20 regarding weather, the calculating unit 13 counts each of the number of summer days and the number of hot summer days, classified by region and by year. At this point, plural pieces of data having the three categories “regional name”, “year”, and “temperature” are accumulated in the database 20. The number of summer days and the number of hot summer days are calculated based on the category “temperature” in the data. Data of the calculated numbers of summer days and hot summer days are displayed as a stacked bar graph in which they are stacked by region and by year.

The “width series” described in the triaxial rendering processing in FIG. 6 refers to the series of the category on a width axis 200 in FIG. 5, the “depth series” refers to the series of the category on a depth axis 210 in FIG. 5, and the “height series” refers to the series of the category on a height axis 220 in FIG. 5. In the embodiment, the category of the width series is “regional name”, and the values of the category of the width series are “Otaru”, “Tokyo”, “Kyoto”, and “Naha”. The category of the depth series is “year”, and the values of the category of the depth series are “2010”, “2011”, and “2012”. The category of the height series is number of days, and the values of the category of the height series are “summer days” and “hot summer days”. In the case of the graph 100 in FIG. 5, the height series has a stack structure in which the number of hot summer days is stacked on the number of summer days.

Upon starting the triaxial rendering processing illustrated in FIG. 6, the graph creating unit 14 determines whether or not there is an unprocessed depth series (step S50). At this point, no bar in the graph has been created. Thus, the graph creating unit 14 determines that there is an unprocessed depth series, advances to the next series (step S52), and determines whether or not there is an unprocessed height series (step S54).

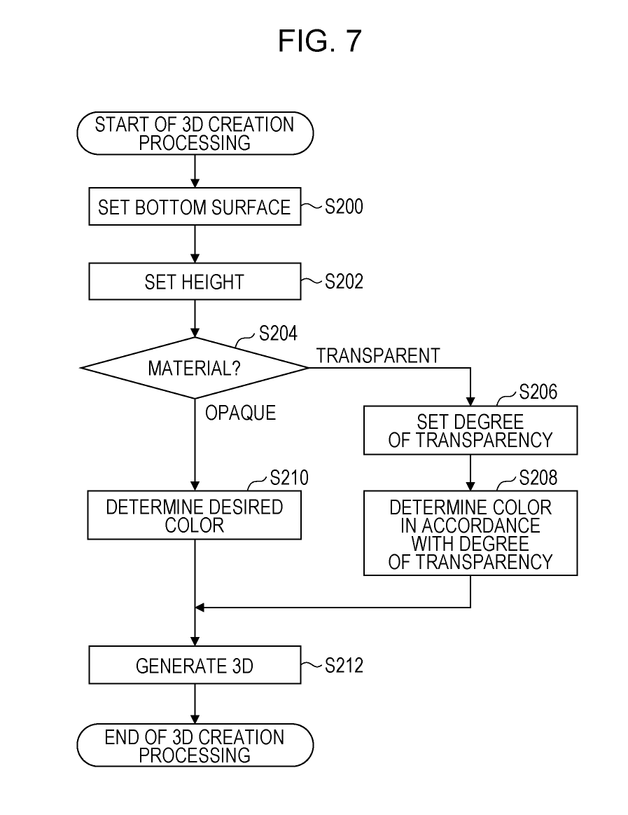

At this point, no bar in the graph has been created. Thus, the graph creating unit 14 determines that there is an unprocessed height series, advances to the next series (step S56), and determines whether or not there is an unprocessed width series (step S58). At this point, no bar in the graph has been created. Thus, the graph creating unit 14 determines that there is an unprocessed width series, advances to the next series (step S60), and executes three-dimension (3D) creation processing (step S62). The 3D creation processing is processing for creating a two-dimensional image for a 3D graphic of a bar in a bar graph for the series that is to be processed at this point. At this point, a two-dimensional image for a 3D graphic of a bar is (hereinafter simply referred to as a “bar” or a “3D graphic of a bar”) for the depth series “2010”, the width series “Otaru”, and the height series “summer day” in the graph 100 illustrated in FIG. 5 is created. The 3D creation processing (FIG. 7) is described later.

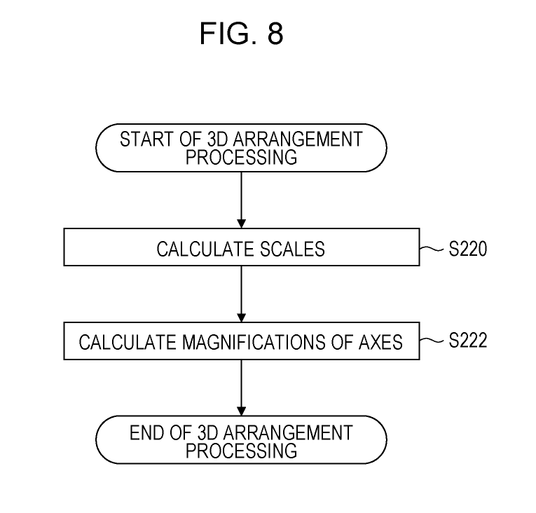

Next, the graph creating unit 14 executes 3D arrangement processing (step S64). The 3D arrangement processing is processing for arranging, in the graph 100, the bar created in the 3D creation processing. The 3D arrangement processing (FIG. 8) is described later. At this point, the 3D graphic of the bar is indicating summer days in Otaru in year 2010 is arranged at the position of “Otaru” in year “2010” in the graph 100 in FIG. 5.

Next, the process returns to step S58, and the graph creating unit 14 determines whether or not there is an unprocessed width series. At this point, “Tokyo”, “Kyoto”, and “Naha” are unprocessed. Thus, the graph creating unit 14 advances to the next series (step S60), executes the 3D creation processing for summer days in Tokyo in year —2010 (step S62), and arranges the 3D graphic of a bar 2a indicating summer days in Tokyo in year 2010 at the position of “Tokyo” in year “2010” (step S64). Next, the graph creating unit 14 sequentially repeats the processes in steps S58 to S64 on the unprocessed width series “Kyoto” and “Naha”, thereby rendering a bar 3a indicating summer days in Kyoto in year 2010 and a bar 4a indicating summer days in Naha in year 2010.

Next, the process returns to step S58 in which the graph creating unit 14 determines whether or not there is an unprocessed width series. At this point, there is no unprocessed width series. Thus, the process returns to step S54, and the graph creating unit 14 determines whether or not there is an unprocessed height series. At this point, the height series for “hot summer day” in year 2010 is unprocessed. Thus, the graph creating unit 14 advances to the next series (step S56) and determines whether or not there is an unprocessed width series (step S58). At this point, all of the width series for “hot summer day” are unprocessed. Thus, the graph creating unit 14 advances to the next series (step S60) and executes the 3D creation processing in step S62 and the 3D arrangement processing in step S64. As a result, in the graph 100 illustrated in FIG. 5, a bar 1b indicating hot summer days in Otaru in year 2010 is rendered on the bar is indicating “summer day”. Steps S58 to S64 are repeated in the manner described above, so that bars 2b, 3b, and 4b indicating “hot summer day” in Tokyo, Kyoto, and Naha in year 2010 are rendered on the bars 2a, 3a, 4a indicating “summer day” in the respective regions.

Next, the process returns to step S58, and the graph creating unit 14 determines whether or not there is an unprocessed width series. At this point, there is no unprocessed width series for year 2010. Thus, the process returns to step S54 in which the graph creating unit 14 determines whether or not there is an unprocessed height series. At this point, there is no unprocessed height series for year 2010. Thus, the process returns to step S50, and the graph creating unit 14 determines whether or not there is an unprocessed depth series. At this point, years “2011” and “2012” are unprocessed. Thus, the graph creating unit 14 advances to the next series (step S52) and determines whether or not there is an unprocessed height series (step S54). At this point, the height series for year “2011” is unprocessed. Thus, the graph creating unit 14 advances to the next series (step S56) and determines whether or not there is an unprocessed width series (step S58). At this point, the width series for “summer days” in year “2011” is unprocessed. Thus, the graph creating unit 14 sequentially performs the processes in steps S58 to S64 on the unprocessed width series “Otaru”, “Tokyo”, “Kyoto”, and “Naha”. As a result, bars 5a to 8a indicating summer days in the regions “Otaru”, “Tokyo”, “Kyoto”, and “Naha” in year 2011 are arranged at the positions of the respective regions in year “2011” in the graph 100 illustrated in FIG. 5.

Next, the graph creating unit 14 returns to step S54. Since the series “hot summer day” in year “2011” is unprocessed, the graph creating unit 14 advances to the next height series “hot summer day” (step S56) and repeatedly executes the processes in steps S58 to S64 until there is no unprocessed width series. As a result, bars 5b to 8b indicating hot summer days in the regions “Otaru”, “Tokyo”, “Kyoto”, and “Naha” in year 2011 are arranged at the positions of the respective regions in year “2011”.

At this point, there is neither an unprocessed width series nor an unprocessed depth series. Thus, the process returns to step S50, and the graph creating unit 14 executes the processes in steps S50 to S64 on the unprocessed depth series “year 2012”. As a result, bars 9a to 12a indicating “summer days” and bars 9b to 12b indicating “hot summer days” in the regions “Otaru”, “Tokyo”, “Kyoto”, and “Naha” in year 2012 are arranged at the positions of the respective regions in year “2012”. Thereafter, the graph creating unit 14 determines in step S50 that there is no unprocessed depth series and then ends the triaxial rendering processing.

(3D Creation Processing)

Now, an example of the 3D creation processing called in step S62 in FIG. 6 will be described with reference to FIG. 7. FIG. 7 is a diagram illustrating an example of an operational flowchart for 3D creation processing, according to an embodiment. In this case, a description will be given of a case in which a two-dimensional image for a 3D graphic of a bar by region and by year, the bar being displayed in the graph, is created.

Upon starting the 3D creation processing, the graph creating unit 14 sets a bottom surface (X, Y) of the bar in the graph (step S200). X of the bottom surface (X, Y) indicates the width of the bottom surface of the bar, and Y indicates the depth of the bottom surface of the bar. The graph creating unit 14 calculates the bottom surface (X, Y) of the bar, based on parameters of data used for the graph. After step S202, the graph creating unit 14 sets the height of the bar (step S202). The graph creating unit 14 calculates each of the heights of the bars for summer days and hot summer days, based on the corresponding number of summer days and number of hot summer days, classified by region and by year. For example, during creation of the bar 1a for Otaru in year 2010 illustrated in FIG. 5, the graph creating unit 14 sets the height of the bar 1a, based on the number of summer days in Otaru in year 2010.

Next, the graph creating unit 14 determines material used for displaying the bar in the graph (step S204). The material used for displaying the bar in the graph is a parameter for creating the graph, and transparency or opaqueness, color, and so on are set in accordance with default values or a user operation. For transparency, the graph creating unit 14 sets a degree of transparency (step S206) and determines a color in accordance with the degree of transparency (step S208). For opaqueness, the graph creating unit 14 determines a desired color (step S210). Next, the graph creating unit 14 generates a two-dimensional image for a 3D graphic in which the bar with the set bottom surface and height is displayed in the determined color (step S212) and then ends the 3D creation processing.

(3D Arrangement Processing)

Next, an example of the 3D arrangement processing called in step S64 in FIG. 6 will be described with reference to FIG. 8. FIG. 8 is a diagram illustrating an example of an operational flowchart for 3D arrangement processing, according to an embodiment. In the 3D arrangement processing, the 3D graphic of the bar created in the 3D creation processing in FIG. 7 is arranged in the graph 100.

Upon starting the 3D arrangement processing, the graph creating unit 14 calculates scales (step S220). Through analysis of the distribution of data to be displayed in the graph 100, the scales are set at such values that the rendering range of the graph becomes optimum.

Next, the graph creating unit 14 calculates magnifications of the respective width axis, depth axis, and height axis (step S222). Spatial axes rendered on the screen may be extended or shrunk and the magnifications thereof may be varied. The graph creating unit 14 arranges the 3D graphic of each bar in a space defined by the width axis, depth axis, and height axis displayed with the calculated magnifications and then ends the 3D arrangement processing. As a result of the processing described above, the bars is to 12a indicating the numbers of summer days and the bars 1b to 12b indicating the numbers of hot summer days, the numbers being classified by region and by year and the bars is to 12a and 1b to 12b being depicted in FIG. 5, are displayed in the graph 100.

[Operation for Varying Lengths of Axes]

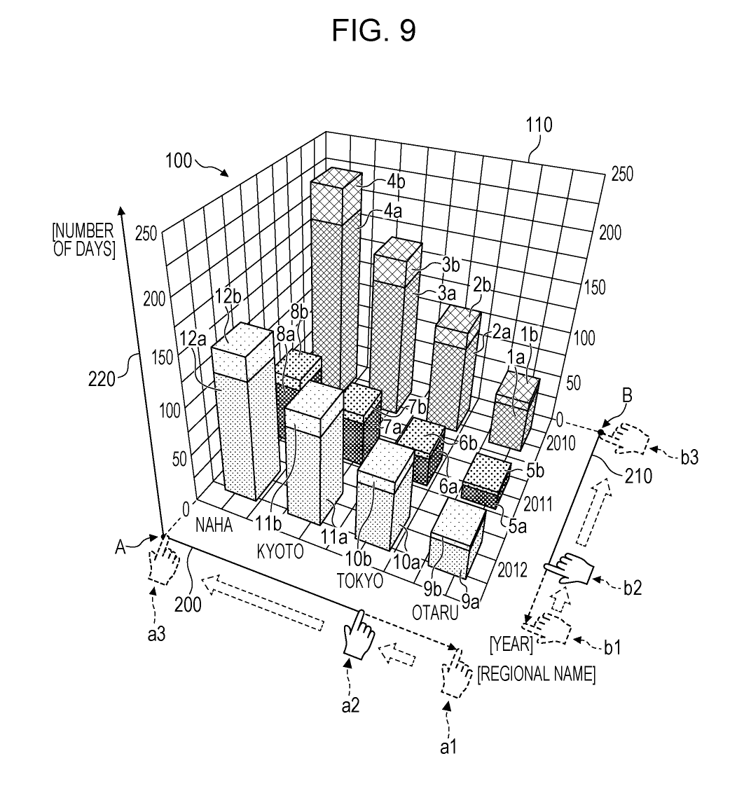

Next, an example of a manipulation for varying the lengths of the axes will be described with reference to FIGS. 9 to 11. FIGS. 9 to 11 illustrate examples of axis operations, according to an embodiment. FIG. 9 illustrates an example in which the user manipulates the axes while touching or near-touching one or both of the width axis 200 and the depth axis 210 of the graph with his or her finger.

The screen for displaying the graph 100 has a touch panel function that is capable of detecting a contact or near-contact state of a finger. It is possible for the user to vary the length of each axis by touching the screen with his or her finger and swiping the axis or sliding the finger on the axis. The user may also vary the length of the axis by performing an operation of quickly swiping the finger that is in contact with the screen (that is, a flicking operation) or by performing an operation of touching the screen (that is, a tapping operation). The user may also vary the length of the axis by moving a cursor of a mouse or a predetermined pen, instead of the finger, along the axis.

For example, the user touches a position a1 on the width axis 200, displayed on the screen, with his or her finger or places the finger near the position a1 and slides the finger to a position a2. As a result, the length of the width axis 200 is reduced by an amount corresponding to the distance between the position a1 and the position a2, so that the scale of the width axis 200 is reduced. In this case, although not illustrated in FIG. 9, the representations in the width direction of the bars in the graph 100 shrink by an amount equal to the length of the width axis 200.

When the user further slides the finger to a position a3, the position a3 of the finger matches a base point A of the graph 100 for the width axis 200 (that is, a point that serves as a base for the width axis 200 and for the width direction of the graph 100), and the length of the width axis 200 reaches zero. At this point, all of the representations in the width direction of the bars in the graph 100 overlap each other.

As described above, the operation for setting the length of the width axis 200 at zero (or a superimposing operation) may also be a user operation for sliding the finger to the base point A for the width axis 200 or a position near the base point A. That is, the operation for setting the length of the width axis 200 at zero includes not only an operation by which the length of the width axis 200 on the graph is set at zero but also an operation by which the length of the width axis 200 on the graph is set at a minimum value other than zero.

The operation for setting the length of the width axis 200 at zero (or a superimposing operation) may also be an operation for shrinking the width axis 200 by performing an operation of quickly swiping, in the direction of the base point A, the finger that is in contact with an end of the width axis 200, any other position on the width axis 200, or a position near the width axis 200 (that is, a flicking operation). In this case, the flicking operation may be performed once or may be repeated a number of times, for example, until the length of the width axis 200 on the graph reaches a value that is smaller than or equal to a predetermined value, such as zero, a minimum value, or a pre-defined threshold.

The operation for setting the length of the width axis 200 at zero may also be an operation for shrinking the width axis 200 by a tapping operation at the base point A of the width axis 200, one end of the width axis 200, any other position on the width axis 200, or a position near the width axis 200. The tapping operation may also be performed once or may be repeated a number of times until the length of the width axis 200 on the graph reaches a value that is smaller than or equal to a predetermined value, such as zero, a minimum value, or a pre-defined threshold. The operation for setting the length of the width axis 200 at zero may also be an operation like superimposing the end of the width axis 200, displayed on the graph 100, on the base point A of the width axis 200 or on a position near the base point A.

When the user performs the operation for setting the length of the width axis 200 at zero, the width axis 200 may be made to disappear from the graph, that is, may be hidden, or the width axis 200 may be left displayed.

With respect to the depth axis 210, similarly, for example, when the user touches a position b1 on the depth axis 210, displayed on the screen, with his or her finger or places the finger near the position b1 and slides the finger to a position b2, the length of the depth axis 210 is reduced by an amount corresponding to the distance between the position b1 and the position b2, so that the scale of the depth axis 210 is reduced. In this case, the representations in the depth direction of the bars in the graph 100 shrink by an amount equal to the length of the depth axis 210.

When the user slides the finger to a position b3, the position b3 of the finger matches a base point B of the graph 100 for the depth axis 210 (that is, a point that serves as a base for the depth axis 210 and the depth direction of the graph 100), so that the length of the depth axis 210 reaches zero. At this point, all of the representations in the depth direction of the bars in the graph 100 overlap each other.

Thus, the operation for setting the length of the depth axis 210 at zero may be a user operation for sliding his or her finger to the base point B for the depth axis 210 or to a position near the base point B. That is, the operation for setting the length of the depth axis 210 at zero includes not only an operation by which the length of the depth axis 210 on the graph reaches zero but also an operation by which the length of the depth axis 210 on the graph reaches a minimum value other than zero.

The operation for setting the length of the depth axis 210 at zero may also be an operation for shrinking the depth axis 210 by performing an operation of quickly swiping, in the direction of the base point B, the finger that is in contact with an end of the depth axis 210, any other position on the depth axis 210, or a position near the depth axis 210 (that is, a flicking operation). The flicking operation may also be performed once or may be repeated a number of times until the length of the depth axis 210 on the graph reaches a value that is smaller than or equal to a predetermined value, such as zero, a minimum value, or a pre-defined threshold.

The operation for setting the length of the depth axis 210 at zero may also be an operation for shrinking the depth axis 210 by a tapping operation at the base point B of the depth axis 210, one end of the depth axis 210, any other position on the depth axis 210, or a position near the depth axis 210. The tapping operation may also be performed once or may be repeated a number of times until the length of the depth axis 210 on the graph reaches a value that is smaller than or equal to a predetermined value, such as zero, a minimum value, or a pre-defined threshold. The operation for setting the length of the depth axis 210 at zero may be an operation like superimposing the end of the depth axis 210, displayed on the graph 100, on the base point B for the depth axis 210 or on a position near the base point B.

When the user performs the operation for setting the length of the depth axis 210 at zero, the depth axis 210 may be made to disappear from the graph, that is, may be hidden, or the depth axis 210 may be left displayed. The user may also perform an operation for varying the length the height axis 220.

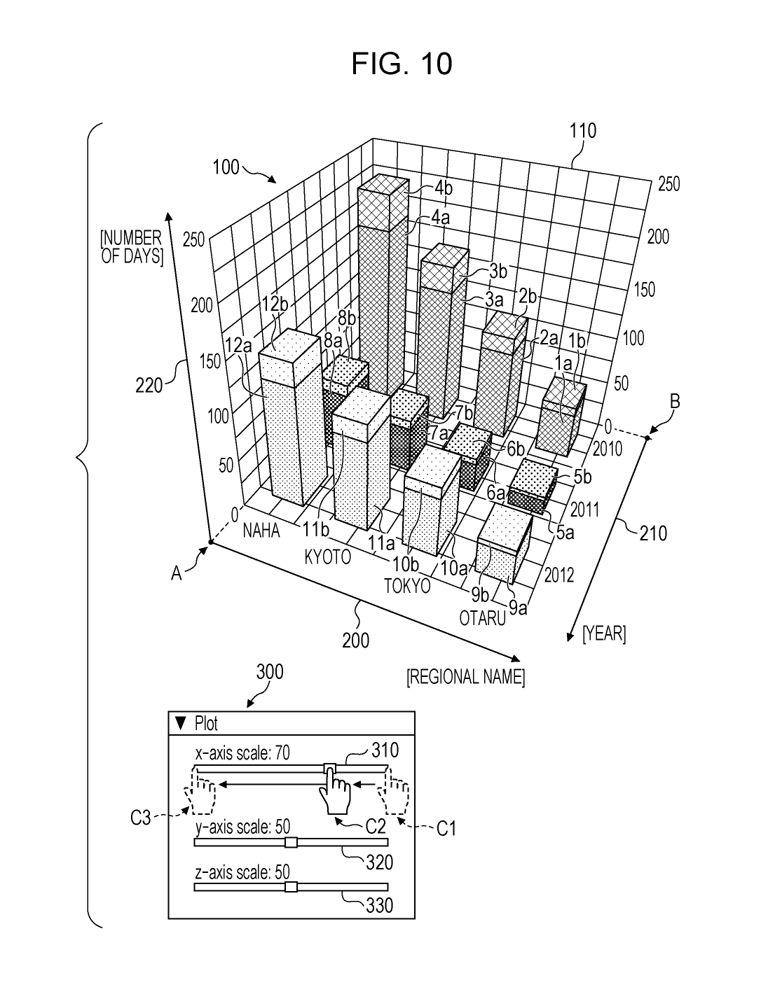

Now, an example of performing an operation for setting the length of each axis at zero by using a setting screen 300 on which images representing the axes of the graph 100 are rendered, instead of performing the operation by touching the axes of the graph 100, will be described with reference to FIG. 10. The setting screen 300 may be displayed together with the graph 100 but separately from the axes of the graph 100. The setting screen 300 displays a slider 310 for the width axis (x-axis), a slider 320 for the height axis (y-axis), and a slider 330 for the depth axis (z-axis). The slider 310 corresponds to the width axis of the graph 100, the slider 320 corresponds to the height axis of the graph 100, and the slider 330 corresponds to the depth axis of the graph 100.

FIG. 10 is a diagram illustrating an example of an operation for manipulating a slider, according to an embodiment. In FIG. 10, a user manipulates the slider 310 for the width axis. The user can shrink the representation in the width direction of the graph 100 up to 70% of its maximum representation by sliding his or her finger from a position c1 to a position c2. When the user slides his or her finger to a left-end position c3 of the slider 310 (that is, to the left end of the slider 310 which corresponds to the base point of the width axis), this means that the operation for setting the length of the width axis at zero has been performed.

Similarly, performing an operation on the slider 320 makes it possible to enlarge/shrink the representation in the height direction of the graph 100. Also, performing an operation on the slider 330 makes it possible to enlarge/shrink the representation in the depth direction of the graph 100. When the user slides his or her finger to the left-end position of the slider 320 (that is, to the left end of the slider 320 which corresponds to the base point of the height axis), this means that the operation for setting the length of the height axis at zero has been performed. The sliders 310, 320, and 330 may also be manipulated using the cursor of the mouse.

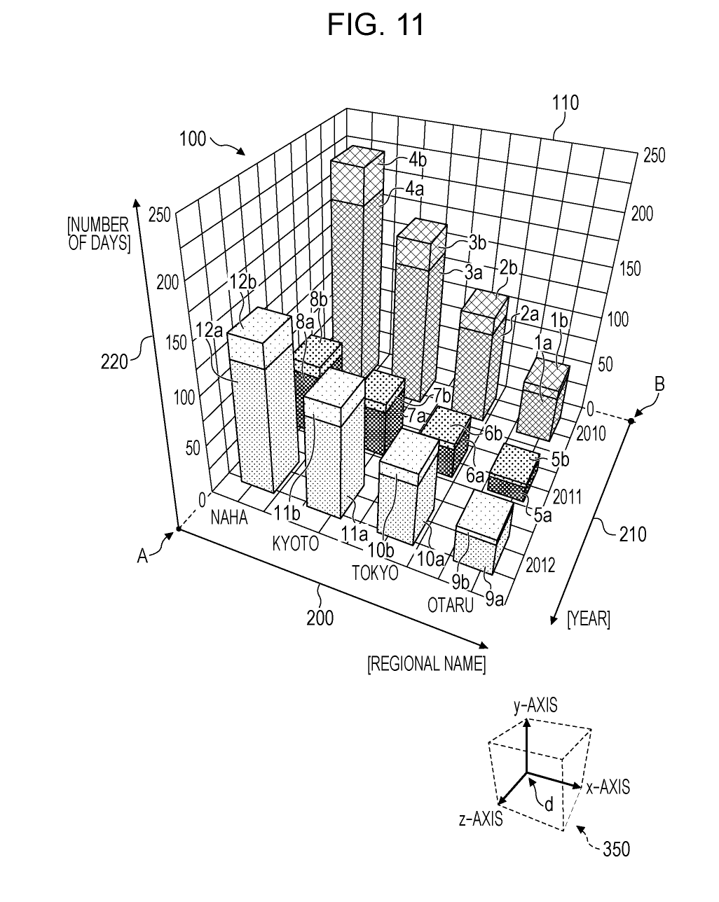

An example in which an operation for setting the length of each axis at zero by using a handle 350 on which images representing the axes of the graph 100 are rendered, the images being displayed separately from the axes of the graph 100, is performed instead of performing an operation by touching the axis of the graph 100 will now be described with reference to FIG. 11. The operation handle 350 displays three operation axes, namely, an x-axis, a y-axis, and a z-axis. The x-axis corresponds to the width axis of the graph 100, the y-axis corresponds to the height axis of the graph 100, and the z-axis corresponds to the depth axis of the graph 100. The user may also enlarge/shrink each operation axis by using his or her finger or a mouse. When the user moves the finger or the cursor of the mouse to the base point d of each axis or to a position near the base point d, this means that the operation for setting the length of the axis at zero has been performed. For example, when the user moves the operation axis for the x-axis to the base point d with his or her finger, this means that the operation for setting the length of the width axis at zero has been performed. Also, when the user moves the operation axis for the y-axis to the base point d with his or her finger, this means that the operation for setting the length of the height axis at zero has been performed. Also, when the user moves the operation axis for the z-axis to the base point d with his or her finger, this means that the operation for setting the length of the depth axis at zero has been performed.

The operations (described above with reference to FIGS. 9 to 11) for setting the length of each axis at zero may also be performed on the plurality of axes. In this case, the user may perform operations for setting the lengths of the plurality of axes at zero in order one by one or may perform the operations in parallel. For example, the user may perform the operation for setting the length of the depth axis at zero after performing the operation for setting the length of the width axis at zero or may perform the operation for setting the length of the width axis at zero after performing the operation for setting the length of the depth axis at zero. The user may also perform the operation for setting the length of the width axis at zero and the operation for setting the length of the depth axis at zero in parallel.

A specific example of the operation for setting the length of the axis at zero has been described above. As described above, the operation for setting the length of each axis at zero may be an operation for shrinking the axis from the end of the axis, displayed on the graph, toward the base point of the axis so that the axis reaches a predetermined length or smaller (the predetermined length refers to, for example, zero, a length having a minimum value, or a pre-defined threshold). Alternatively, the operation for setting the length of the axis at zero may be an operation for shrinking the axis, displayed on the graph, from one end of the axis toward the base point of the axis until the axis reaches a predetermined length or smaller, by manipulating images that are displayed separately from the axes displayed on the graph and is representative of the axes of the graph.

[Biaxial Rendering Processing (Width-Axis Average Values)]

Next, a description will be given of graph creation executed in accordance with the above-described operation for setting the length of the axis at zero. First, an example of the biaxial rendering processing (width-axis average values) called in step S40 in FIG. 4 will be described with reference to FIG. 12. FIG. 12 is a diagram illustrating an example of an operational flowchart for biaxial rendering processing (width-axis average values), according to an embodiment. The biaxial rendering processing (width-axis average values) is executed when the operation for setting the length of the width axis at zero is performed.

Upon starting the biaxial rendering processing (width-axis average values), the graph creating unit 14 determines whether or not there is an unprocessed depth series (step S70). At this point, no bar in the graph has been created. Thus, the graph creating unit 14 determines that there is an unprocessed depth series, advances to the next series (step S72), and determines whether or not there is an unprocessed height series (step S74). The graph creating unit 14 determines in step S74 that there is an unprocessed height series, advances to the next series (step S76), and determines whether or not there is an unprocessed width series (step S78). In step S78, the graph creating unit 14 also determines that there is an unprocessed width series. Thus, the process advances to the next series (step S80), and the calculating unit 13 adds the data of summer days in Otaru in year 2010 for each element value (step S82). In this case, element values of the data include a numerical value indicating the number of summer days in Otaru in year 2010 and a numerical value indicating the color in which the bar for summer days in Otaru in year 2010 is displayed, and the numerical values are individually added in step S82. Examples of the numerical value indicating the color in which the bar is displayed include RGB values that numerically specify the respective luminances of red, green, and blue components.

After step S82, the process returns to step S78 in which the graph creating unit 14 determines whether or not there is an unprocessed width series. At this point, “Tokyo”, “Kyoto”, and “Naha” are unprocessed. Thus, the process advances to the next series (step S80), and the calculating unit 13 adds the data of summer days in Tokyo in year 2010 for each element value (step S82). More specifically, the calculating unit 13 adds a numerical value indicating the number of summer days in Tokyo in year 2010 to the numerical value indicating the number of summer days in Otaru in year 2010. The calculating unit 13 also adds a numerical value indicating the color in which the bar for summer days in Tokyo in year 2010 is displayed to the numerical value indicating the color in which the bar for summer days in Otaru in year 2010 is displayed.

Similarly, the processes in steps S78 to S82 are performed until there is no unprocessed width series. As a result, the total addition value of the numerical values indicating the numbers of summer days in the four regions in year 2010 and the total addition value of the numerical values indicating the colors in which the bars for summer days in the four regions in year 2010 are displayed are determined.

After step S82, the process returns to step S78 in which the graph creating unit 14 determines whether or not there is an unprocessed width series. At this point, there is no unprocessed width series. Thus, the calculating unit 13 calculates average values, based on the total addition values (step S84). The average values calculated in this case are two average values: an average value of the numbers of summer days in the four regions in year 2010 and an average value of the colors in which the bars for summer days in the respective regions in year 2010 are displayed.

For example, in the case of the table in FIG. 2A indicating the numbers of summer days, the data of the numbers of summer days, the data being grouped by year 2010, indicate “48”, “81”, “128”, and “174”. Thus, in this case, based on the total addition value “431”, the calculating unit 13 determines an average value “107.75” of the numbers of summer days.

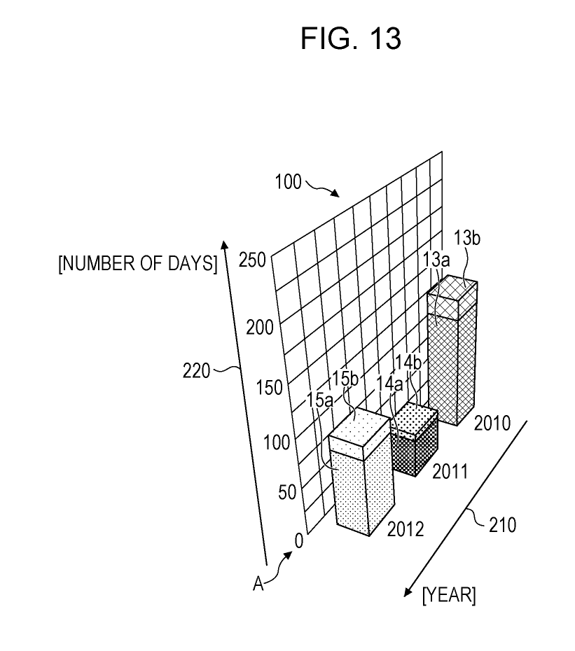

Next, the graph creating unit 14 executes the 3D creation processing for summer days in year 2010 (step S86) and then executes the 3D arrangement processing (step S88). As a result, as illustrated in FIG. 13, a bar 13a indicating the average value of the numbers of summer days in the four regions in year 2010 is arranged along an extension of the base point A of the graph. In this case, the bar 13a is displayed with the determined average value of the colors.

After step S88 in FIG. 12, the process returns to step S74 in which the graph creating unit 14 determines whether or not there is an unprocessed height series. At this point, the series “hot summer day” in year 2010 is unprocessed. Thus, the process advances to the next series (step S76), and the calculating unit 13 repeatedly executes the processes in steps S78 to S82 on Otaru, Tokyo, Kyoto, and Naha. In step S84, the calculating unit 13 calculates an average value of the numbers of hot summer days in the four regions in year 2010 and an average value of the colors in which the bars for hot summer days in the respective regions in year 2010 are displayed.

For example, in the case of the table in FIG. 2B indicating the numbers of hot summer days, the data of the numbers of hot summer days, the data being grouped by year 2010, are “5”, “10”, “20”, and “38”. Thus, in this case, based on the total addition value “73”, the calculating unit 13 determines an average value “18.25” of the numbers of hot summer days.

Next, the graph creating unit 14 executes the 3D creation processing based on the average value of the numbers of hot summer days in the four regions in year 2010 and the average value of the colors in the graph (step S86). The graph creating unit 14 performs arrangement by stacking a bar 13b indicating the average value of the numbers of hot summer days in the four regions in year 2010 on the bar 13a (step S88), as illustrated in FIG. 13. In this case, the bar 13b is displayed with the determined average value of the colors.

Next, the process returns to step S74 in FIG. 12 in which the graph creating unit 14 determines whether or not there is an unprocessed height series. At this point, there is no unprocessed height series. Thus, the process returns to step S70, and the graph creating unit 14 determines whether or not there is an unprocessed depth series (step S70). At this point, years 2011 and 2012 are unprocessed. Thus, the processes in steps S72 to S88 are executed, and a bar 14b indicating the average value of the numbers of hot summer days in the four regions in year 2011 is stacked on a bar 14a indicating the average value of the numbers of summer days in the regions in year 2011 along the extension of the base point A of the graph, and the bars 14a and 14b are displayed with the determined average values of the colors, as illustrated in FIG. 13.

Similarly, the processes in steps S70 to S88 are executed on “year 2012”, which is an unprocessed depth series. As a result, as illustrated in FIG. 13, a bar 15b indicating the average value of the numbers of hot summer days in the four regions in year 2012 is stacked on a bar 15b indicating the average value of the numbers of summer days in the regions in year 2012 along the extension of the base point A of the graph, and the bars 15a and 15b are displayed with the determined average values of the colors.

The description thus far has been given of the biaxial rendering processing (width-axis average values) according to the embodiment. In the biaxial rendering processing (width-axis average values) according to the embodiment, the operation for setting the length of the width axis at zero is performed on the graph in which multiple pieces of data having three categories “regional name”, “year”, and “number of days” for summer days and hot summer days are displayed. In response to the operation, the average value of “number of days” for summer days and the average value of “number of days” for hot summer days, the “number of days” being the category on the height axis, are determined for each data set in which the values of “year”, which is the category on the depth axis, match each other are determined. Then, a graph displaying the depth axis, the height axis, and the determined average values is created. Thus, the operation for setting the length of the width axis at zero makes it possible to create a graph that enables visual recognition of the average values in a data set in the width direction, the average values being displayed in the graph 100.

Thus, the operation for setting the length of the width axis at zero (or a superimposing operation) may also be said to be an operation performed so as to superimpose bars for each year for all of the values (Otaru, Tokyo, Kyoto, and Naha) of the category on the width axis. The operation is also an intuitive operation by which the user is able to easily recognize the average values of the numbers of summer days and the numbers of hot summer days in the four regions for each year, the average values being displayed in a graph that is created in response to the operation. Accordingly, in the embodiment, by performing the operation for setting the length of the width axis at zero, the user is able to visually recognize that the average values of the numbers of summer days and the numbers of hot summer days in the four regions for each year are displayed in the created graph.

In such a drawing creation method according to the embodiment, a special operation button for giving an instruction for displaying the average values in the graph may be omitted from the operation panel. This makes it possible to simplify the structure of the operation panel.

Next, a description will be given of the biaxial rendering processing (depth-axis average values) according to an embodiment.

[Biaxial Rendering Processing (Depth-Axis Average Values)]

An example of the biaxial rendering processing (depth-axis average values) called in step S36 in FIG. 4 will be described with reference to FIG. 15. FIG. 15 is a diagram illustrating an example of an operational flowchart for biaxial rendering processing (depth-axis average values), according to an embodiment. The biaxial rendering processing (depth-axis average values) is executed when the operation for setting the length of the depth axis at zero is performed.

Upon starting the biaxial rendering processing (depth-axis average values), the graph creating unit 14 determines whether or not there is an unprocessed width series (step S90). At this point, no bar in the graph has been created. Thus, the graph creating unit 14 determines that there is an unprocessed width series, advances to the next series (step S92), and determines whether or not there is an unprocessed height series (step S94). In step S94, the graph creating unit 14 determines that there is an unprocessed height series. The process then advances to the next series (step S96), and the graph creating unit 14 determines whether or not there is an unprocessed depth series (step S98). In step S98, the graph creating unit 14 also determines that there is an unprocessed depth series. Thus, the process advances to the next series (step S100), and the calculating unit 13 adds the data of summer days in Otaru in year 2010 for each element value (step S102). In this case, element values of the data include a numerical value indicating the number of summer days in Otaru in year 2010 and a numerical value indicating the color in which the bar for summer days in Otaru in year 2010 is displayed, and the numerical values are individually added in step S102.

The process returns to step S98 in which the graph creating unit 14 determines whether or not there is an unprocessed depth series. At this point, years “2011” and “2012” are unprocessed. Thus, the process advances to the next series (step S100), and the calculating unit 13 adds the data of summer days in Otaru in year 2011 for each of the element values (that is, the number of summer days and the color) (step S102). Similarly, the processes in steps S98 to S102 are performed until there is no unprocessed depth series. As a result, a total addition value of the numerical values indicating the numbers of summer days in Otaru in year 2010 to year 2012 and a total addition value of the numerical values indicating the colors in the graph in which the bars for summer days in Otaru in year 2010 to year 2012 are displayed are determined.

Next, the process returns to step S98 in which the graph creating unit 14 determines whether or not there is an unprocessed depth series. At this point, there is no unprocessed depth series. Thus, the calculating unit 13 calculates average values (step S104). The average values calculated in this case are two average values: an average value of the numbers of summer days in Otaru in the three years and an average value of the colors of bars indicating the numbers of summer days in Otaru in the three years.

In the case of the table in FIG. 2A indicating the numbers of summer days, the data of the numbers of summer days, the data being grouped by Otaru, are “48”, “21”, and “38”. Thus, in this case, based on the total addition value “107”, the calculating unit 13 determines an average value “35.67” of the numbers of summer days.

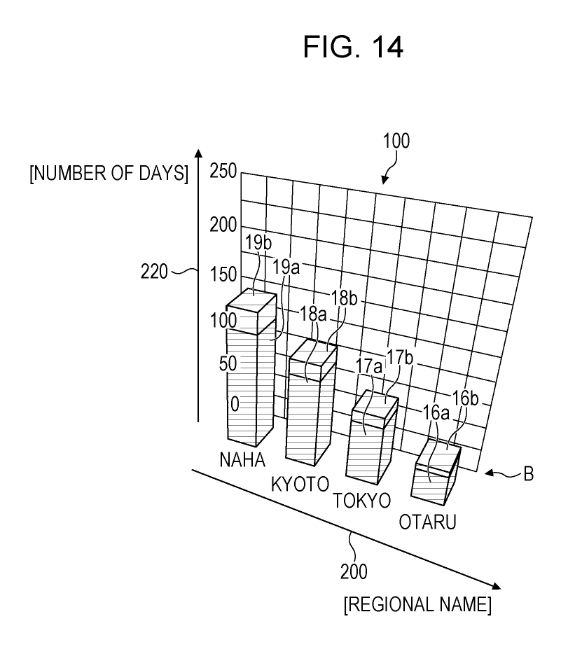

Next, the graph creating unit 14 executes the 3D creation processing for summer days in Otaru (step S106) and then executes the 3D arrangement processing (step S108). As a result, as illustrated in FIG. 14, a bar 16a indicating the average value of the numbers of summer days in Otaru in the three years is arranged along an extension of the base point B of the graph. At this point, the bar 16a is displayed with the determined average value of the colors.

Next, the process returns to step S94 in FIG. 15, and the graph creating unit 14 determines whether or not there is an unprocessed height series. At this point, the series “hot summer day” in Otaru is unprocessed. Thus, the process advances to the next series (step S96), and the calculating unit 13 repeatedly executes the processes in steps S98 to S102 on year 2011 and year 2012. Thereafter, in step S104, the calculating unit 13 calculates the average value of the numbers of hot summer days in Otaru in the three years and the average value of the colors of the bars for hot summer days in Otaru in the three years.

For example, in the case of the table in FIG. 2B indicating the numbers of hot summer days, the data of the numbers of hot summer days, the data being grouped by Otaru, are “5”, “2”, and “4”. Thus, in this case, the calculating unit 13 determines an average value “3.67” of the numbers of hot summer days, based on the total addition value “11”.

Next, the graph creating unit 14 executes the 3D creation processing for hot summer days in Otaru (step S106). The graph creating unit 14 then stacks and arranges a bar 16b indicating the average value of the numbers of hot summer days in Otaru in the three years on the bar 16a indicating the average value of the numbers of summer days (step S108), as illustrated in FIG. 14. In this case, the bar 16b is displayed with the determined average value of the colors.

Next, the process returns to step S94 in FIG. 15, and the graph creating unit 14 determines whether or not there is an unprocessed height series. At this point, there is no unprocessed height series. Thus, the process returns to step S90 in which the graph creating unit 14 determines whether or not there is an unprocessed width series. At this point, Tokyo, Kyoto, and Naha are unprocessed. Thus, the processes in steps S92 to S108 are executed, and bars 17a and 17b indicating the average values of the numbers of summer days and the numbers of hot summer days in Tokyo in the three years are displayed with the determined average values of the colors, as illustrated in FIG. 14. Similarly, the processes in steps S90 to S108 are executed, and bars 18a and 18b and bars 19a and 19b (illustrated in FIG. 14) indicating the average values of the numbers of summer days and the numbers of hot summer days in Kyoto and Naha in the three years are displayed with the determined average values of the colors.

The description thus far has been given of the biaxial rendering processing (depth-axis average values) according to the embodiment. In the biaxial rendering processing (depth-axis average values) according to the embodiment, when the operation for setting the length of the depth axis at zero is performed, the average value of “number of days” for summer days and the average value of “number of days” for hot summer days, the “number of days” being the category on the height axis, are determined for each data set in which the values of “regional name”, which is the category on the width axis, match each other. Then, a graph in which the width axis, the height axis, and the determined average values are displayed is created. Thus, the operation for setting the length of the depth axis at zero makes it possible to create a graph that enables visual recognition of the average values in a data set displayed in the graph 100.

Thus, the operation for setting the length of the depth axis at zero may also be said to be an operation performed so as to superimpose bars for each region for all of the values (2010, 2011, and 2012) of the category on the depth axis. The operation is also an intuitive operation by which the user is able to easily recognize the average values of the numbers of summer days and the numbers of hot summer days in the three years for each region, the average values being displayed in a graph that is created in response to the operation. Thus, in the embodiment, by performing the operation for setting the length of the depth axis at zero, the user is able to visually recognize that the average value of the numbers of summer days and the numbers of hot summer days in the three years for each region is displayed in the created graph.

In the biaxial rendering processing (width-axis average values or depth-axis average values) according to the embodiments described above, the bars indicating the determined average values of the numbers of summer days and the numbers of hot summer days are displayed in the graph by using the determined average values of the colors. However, the bars indicating the average values of the numbers of summer days and the numbers of hot summer days may be displayed in the graph without color. In this case, the processing for determining the average value of the colors (that is, the addition of element values regarding the colors and the determination of the average value) may be omitted.

In the description described above, the graph has been created in accordance with the operation for setting one of the lengths of the width axis and depth axis at zero. Next, a description will be given of graph creation executed in accordance with an operation for setting both of the lengths of the width axis and the depth axis at zero.

[Uniaxial Rendering Processing (Biaxial Average Values)]

An example of the uniaxial rendering processing (biaxial average values) called in step S32 in FIG. 4 will be described with reference to FIG. 16. FIG. 16 is a diagram illustrating an example of an operational flowchart for uniaxial rendering processing, according to an embodiment.

Upon starting the uniaxial rendering processing, the graph creating unit 14 determines whether or not there is an unprocessed height series (step S110). At this point, no bar in the graph has been created. Thus, the graph creating unit 14 determines that there is an unprocessed height series, advances to the next series (step S112), and determines whether or not there is an unprocessed width series (step S114). In step S114, the graph creating unit 14 also determines that there is an unprocessed width series. The process then advances to the next series (step S116), and the graph creating unit 14 determines whether or not there is an unprocessed depth series (step S118). In step S118, the graph creating unit 14 also determines that there is an unprocessed depth series. Thus, the process advances to the next series (step S120), and the calculating unit 13 adds the data of summer days in Otaru in year 2010 for each element value (step S122).

Next, the process returns to step S118 in which the graph creating unit 14 determines whether or not there is an unprocessed depth series. At this point, years 2011 and 2012 are unprocessed. Thus, the process advances to the next series (step S120), and the calculating unit 13 adds the data of summer days in Otaru in year 2011 for each element value (step S122). Similarly, the calculating unit 13 performs the processes in steps S118 to S122 until there is no unprocessed depth series.

As a result, the total addition value of the numerical values indicating the numbers of summer days in Otaru in year 2010 to year 2012 and the total addition value of the numerical values indicating the colors in which the bars for summer days in Otaru in year 2010 to year 2012 are displayed are calculated.

Next, the process returns to step S118 in which the graph creating unit 14 determines whether or not there is an unprocessed depth series. At this point, there is no unprocessed depth series. Thus, the process returns to step S114 in which the graph creating unit 14 determines whether or not there is an unprocessed width series. At this point, Tokyo, Kyoto, and Naha are unprocessed. The calculating unit 13 repeatedly executes the processes in steps S118 to S122 on the category values “Tokyo”, “Kyoto”, and “Naha” in the unprocessed width series, until there is no unprocessed depth series. As a result, the total addition value of the numerical values indicating the numbers of summer days in the three years for each region and the total addition value of the numerical values indicating the colors in which the bars for summer days in the three years for each region are displayed are calculated.

At this point, in step S114, the graph creating unit 14 determines whether or not there is an unprocessed width series. At this point, there is no unprocessed width series. Thus, the calculating unit 13 adds the values of the width series (step S124). That is, the calculating unit 13 adds all of the total addition values of the numerical values indicating the numbers of summer days in the regions Otaru, Tokyo, Kyoto, and Naha in the three years. The calculating unit 13 adds all of the total addition values of the numerical values indicating the colors in which the bars for summer days in the individual regions in the three years are displayed.

Based on the total addition value of the numerical values indicating the numbers of summer days in the four regions in the three years, the calculating unit 13 calculates an average value of the numbers of summer days in the four regions in the three years (step S126). Based on the total addition value of the numerical values indicating the colors in which the bars for summer days in the four regions in the three years are displayed, the calculating unit 13 calculates an average value of the numerical values indicating the colors in which the bars for summer days in the four regions in the three years are displayed (step S126).

For example, in the case of the table in FIG. 2A, the average value of the numbers of summer days may be calculated by adding all of the data of the numbers of summer days in FIG. 2A and dividing the resulting total addition value by 12.

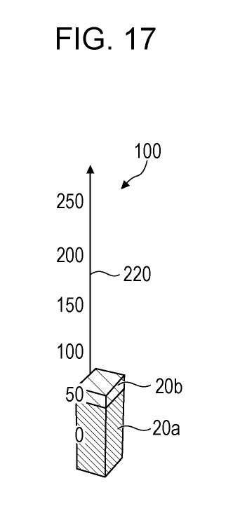

After step S126, the graph creating unit 14 executes the 3D creation processing (step S128) and arranges, with respect to the height axis, a bar 20a indicating the average value of the numbers of summer days in the four regions in the three years (step S130), as illustrated in FIG. 17. In this case, the bar 20a is displayed with the calculated average value of the colors.

Next, the process returns to step S110 in FIG. 16, and the graph creating unit 14 determines whether or not there is an unprocessed height series. At this point, the series “hot summer day” is unprocessed. Thus, the process advances to the next series (step S112), and the calculating unit 13 repeatedly executes the processes in steps S114 to S122 and then adds all of the values of the width series in step S124. Next, the calculating unit 13 calculates an average value of the numbers of hot summer days in the four regions in the three years and an average value of the numerical values indicating the colors in which the bars for hot summer days in the four regions in the three years are displayed (step S126).

For example, in the case of the table in FIG. 2B, the average value of the numbers of hot summer days is calculated by adding all of the data of the numbers of hot summer days in FIG. 2B and dividing the resulting total addition value by 12.

After step S126, the graph creating unit 14 executes the 3D creation processing (step S128) and arranges, with respect to the height axis, a bar 20b indicating the average value of the numbers of hot summer days in the four regions in the three years (step S130), as illustrated in FIG. 17. In this case, the bar 20b is displayed with the calculated average value of the colors.

Next, the process returns to step S110 in which the graph creating unit 14 determines whether or not there is an unprocessed height series. At this point, there is no unprocessed height series. Thus, the uniaxial rendering processing ends.

As described above, in the uniaxial rendering processing according to the embodiment, performing the operation for setting both of the lengths of the width axis and the depth axis in the three-dimensional graph at zero, that is, performing the operation for superimposing all the values of the categories on the width axis and the depth axis, makes it possible to display, in the graph, the average value of the numbers of summer days and the average value of the numbers of hot summer days in the four regions in the three years. Accordingly, in the embodiment, by performing the operation for setting both of the lengths of the width axis and the depth axis at zero, the user is able to visually recognize that the average values of the numbers of summer days and the numbers of hot summer days in the four regions in the three years is displayed in the created graph.

The description thus far has been given of the drawing creation method for the information processing apparatus 10 according to the embodiment. According to the drawing creation method, in response to an operation for setting the length of one of the axes at zero, a graph in which an average value of the values of the category corresponding to the height axis is displayed for each data set in which the values of the category corresponding to another axis match each other is created. This makes it possible to create a graph so as to enable visual recognition of average values in a data set displayed in the graph.

Although a stacked bar graph has been created in the above-described embodiments, a single bar graph may also be created. In the case of a single bar graph, the repeated rendering processing on the height series does not occur. Thus, it is possible to omit the processing for the height series. For example, it is possible to omit steps S54 and S56 in FIG. 6, steps S74 and S76 in FIG. 12, steps S94 and S96 in FIG. 15, and steps S110 and S112 in FIG. 16.

The description in each of the embodiments described above has been given of graph creation in accordance with the operation for setting the length of the axis at zero. However, after an operation for setting the length of the axis at zero is performed, in accordance with an operation for increasing the length of the axis to a length larger than zero again, a graph in which a data set classified for each value of the category corresponding to the operated axis is displayed may also be created. The operation for increasing the length of the axis to a length larger than zero may be an operation performed in a direction opposite to that of the operation (described above with reference to FIGS. 9 to 11) for setting the length of the axis at zero.

For example, in response to an operation for increasing the length of the width axis in the graph 100 in FIG. 17 to a length larger than zero, a graph (illustrated in FIG. 14) that displays the width axis 200, the height axis 220, and the average values of the numbers of summer days and the numbers of hot summer days in the three years for each of the values (Otaru, Tokyo, Kyoto, and Naha) of the category on the width axis 200 may be created.

Also, in response to an operation for increasing the length of the depth axis of the graph 100 in FIG. 17 to a length larger than zero, a graph (illustrated in FIG. 13) that displays the depth axis 210, the height axis 220, and the average values of the numbers of summer days and the numbers of hot summer days in the four regions for each of the values (2010 to 2012) of the category on the depth axis 210 may be created. In addition, with respect to the graphs illustrated in FIGS. 13 and 14, when an operation for increasing the length of the axis to a length larger than zero is performed on the axis on which the operation for setting the length at zero was performed, a graph that has a width axis, a depth axis, and a height axis and that displays multiple pieces of data may also be created.

[Hardware Configuration of Information Processing Apparatus]

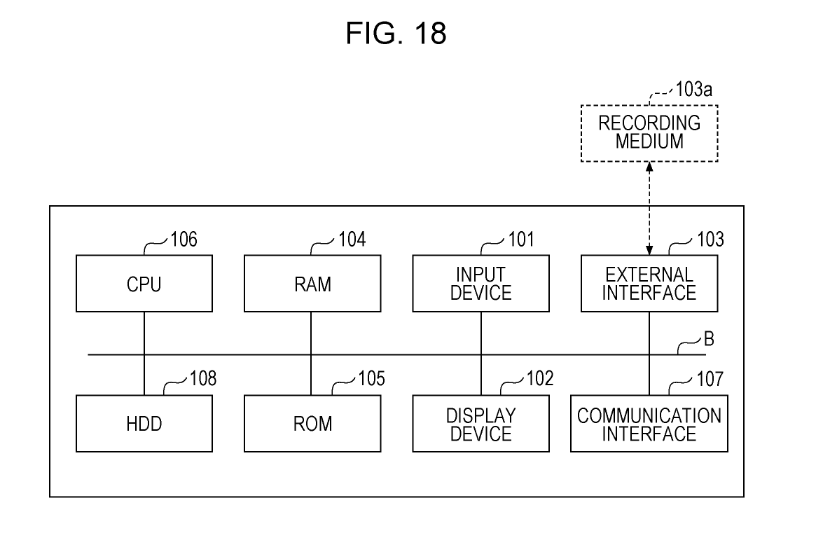

Lastly, an example hardware configuration of the information processing apparatus 10 according to the embodiment will be described with reference to FIG. 18. FIG. 18 is a diagram illustrating an example of a hardware configuration of an information processing apparatus, according to an embodiment.

The information processing apparatus 10 includes an input device 101, a display device 102, an external interface 103, a random access memory (RAM) 104, a read-only memory (ROM) 105, a central processing unit (CPU) 106, a communication interface 107, and a hard disk drive (HDD) 108, which are coupled to one another through a bus B.

The input device 101 includes a keyboard and a mouse and is used to input parameters for a graph to be created and to input an axis operation to the information processing apparatus 10. The functions of the input unit 11 are realized by the input device 101.

The display device 102 includes a display or the like and renders a graph to be created. The functions of the display unit 15 are realized by the display device 102.

The communication interface 107 is an interface for connecting the information processing apparatus 10 to a network. The HDD 108 is a nonvolatile storage device in which programs and data are stored. The programs and data stored in the HDD 108 include, for example, an operating system (OS), which is a basic software for controlling the entire information processing apparatus 10, and application software for creating a graph on the OS. The HDD 108 stores therein various programs the CPU 106 executes in order to create triaxial, biaxial, and uniaxial graphs.

The external interface 103 is an interface for an external device. One example of the external device is a recording medium 103a. The information processing apparatus 10 may perform writing to and/or reading from the recording medium 103a via the external interface 103. Examples of the recording medium 103a include a compact disk (CD), a digital versatile disk (DVD), a Secure Digital (SD) memory card, and a Universal Serial Bus (USB) memory.

The ROM 105 is a nonvolatile semiconductor memory (a storage device) and stores therein a Basic Input/Output System (BIOS) to be executed upon startup, programs for OS setting and network setting, and data. The RAM 104 is a volatile semiconductor memory (a storage device) that temporarily stores programs and data therein. The CPU 106 is a computing device that controls the entire information processing apparatus 10 and realizes the functions thereof by reading out a program and data from the above-described storage device (for example, the HDD 108 or the ROM 105) to the RAM 104 and executing processing.

The functions of the setting unit 12, the calculating unit 13, and the graph creating unit 14 may be realized by processing that a program installed to the HDD 108 or the like causes the CPU 106 to execute.

Although the drawing creation program, the drawing creation method, and the information processing apparatus have been described above in conjunction with the above embodiments, the present disclosure is not limited to the above-described embodiments, and various modifications and improvements may be made thereto within the scope of the present disclosure.

For example, in the embodiments described above, in a graph having a first axis for a first category, a second axis for a second category, and a third axis for a third category, a simple average value of the values of the third category is determined for each data set in which the values of the second category match each other, in response to the operation for setting the length of the first axis at zero. However, a value determined in response to the operation for setting the length of the first axis at zero is not limited to a simple average value and may be a representative value, such as a median, a mode, a weighted average value (weighted mean value), a maximum value, a minimum value, a multiplied value, or a value subjected to a predetermined computational operation. One example is processing in which, based on a total addition value determined by the calculating unit 13 in the embodiment described above, a median, a mode, a weighted average value (weighted mean value), a maximum value, a minimum value, a multiplied value, a value subjected to a predetermined computational operation, or the like is determined, and a graph in which the determined median or the like is displayed is created.

The operation for setting the length of the axis at zero may be an operation for superimposing targets (the bars in the above-described embodiment), displayed in the graph, in the axial direction. For example, the operation for setting the length of the axis at zero may be an operation for sequentially superimposing the bars is and 1b in FIG. 9 on the bars 5a and 5b and the bars 9a and 9b. Similarly, the operation for setting the length of the axis at zero may be an operation for sequentially superimposing the bars 1a and 1b in FIG. 9 on the bars 2a and 2b, the bars 3a and 3b, and the bars 4a and 4b. The operation for setting the length of the axis at zero may also be an operation for superimposing the bars 1a and 1b in FIG. 9 on the bars 12a and 12b. For example, through an operation for superimposing the bars 1a and 1b on the bars 5a and 5b and the bars 9a and 9b, the average value of the data that are grouped by Otaru and that are to be superimposed may be calculated. For example, through an operation for superimposing the bars 1a and 1b on the bars 12a and 12b, the average value of grouped data of all of the bars is to 12a and the bars 1b to 12b, which grouped data are to be superimposed, may be calculated. The operation for setting the length of the axis at zero is an example of an operation for superimposing, on a screen on which a drawing indicating group data is displayed, the grouped data.

The drawing creation program, the drawing creation method, and information processing apparatus according to the above-described embodiments are also applicable to creation of a two-dimensional graphs.

The drawing creation program, the drawing creation method, and information processing apparatus according to the above-described embodiments are also applicable to creation of a table. That is, an operation for superimposing a row or a column in a table on another row or column may be performed.

When the drawing is a graph, the operation for superimposing grouped data may be an operation for shrinking the axis displayed on the graph by performing an operation on the axis or an operation on an image that is displayed separately from the axis and that is representative of the axis. When the drawing is a table, the operation for superimposing grouped data may be an operation for superimposing a row or a column in the table on another row or column in the table.

Upon detection of an operation for returning the grouped data that have been superimposed to a state before the superimposition, a drawing indicating the grouped data before the superimposition may be created. For example, when the user slides his or her finger from the position a3 toward the position a2, an operation for returning the group data to a state before the superimposition may be detected, and upon detection of the operation, a drawing may be created so that a two-dimensional graph (for example, the graph in FIG. 13) is changed to a three-dimensional graph (for example, the graph in FIG. 9).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
upon detecting, on a screen that displays first drawing including two or three category series of first grouped data each associated with different one of categories of the first grouped data, a superimposing operation for superimposing the two or three category series of first grouped data, calculating representative values for each of one or two category series of second grouped data that are generated by superimposing at least one category series of first grouped data in accordance with the superimposing operation;
creating second drawing data including the representative values that are calculated for each of the one or two category series of second grouped data; and
displaying the second drawing data on the screen.

2. The non-transitory, computer-readable recording medium of claim 1, wherein,
when the first drawing data is displayed on the screen as a graph, the superimposing operation is defined as a shrinking operation for shrinking an axis displayed on the graph, the shrinking operation being performed by a first operation performed directly on the axis displayed on the graph or a second operation performed on an image that represents the axis and is displayed separately from the axis on the screen.

3. The non-transitory, computer-readable recording medium of claim 1, wherein,
when the first drawing data is displayed on the screen as a table, the superimposing operation is defined as an operation for superimposing a row or a column in the table on another row or column in the table.

4. The non-transitory, computer-readable recording medium of claim 1, wherein
the representative values for each of the one or two category series of second grouped data are each calculated as an average value of the at least one category series of first grouped data.

5. The non-transitory, computer-readable recording medium of claim 4, wherein
the second drawing data is created as drawing data by which the representative values for each of the one or two category series of second grouped data are each displayed with a color determined based on an average value of colors that have been used for representing the at least one category series of first grouped data.

6. The non-transitory, computer-readable recording medium of claim 1, wherein
the creating the second drawing includes creating, upon detecting a return operation for returning the one or two category series of second grouped data to a state before the superimposing operation, drawing data by which the two or three category series of first grouped data before the superimposing operation are displayed on the screen.

7. A method for causing a computer to execute a process comprising:
upon detecting, on a screen that displays first drawing including two or three category series of first grouped data each associated with different one of categories of the first grouped data, a superimposing operation for superimposing the two or three category series of first grouped data, calculating representative values for each of one or two category series of second grouped data that are generated by superimposing at least one category series of first grouped data in accordance with the superimposing operation;
creating second drawing data including the representative values that are calculated for each of the one or two category series of second grouped data; and
displaying the second drawing data on the screen.

8. The method of claim 7, wherein,
when the first drawing data is displayed on the screen as a graph, the superimposing operation is defined as a shrinking operation for shrinking an axis displayed on the graph, the shrinking operation being performed by a first operation performed directly on the axis displayed on the graph or a second operation performed on an image that represents the axis and is displayed separately from the axis on the screen.

9. The method of claim 7, wherein,
when the first drawing data is displayed on the screen as a table, the superimposing operation is defined as an operation for superimposing a row or a column in the table on another row or column in the table.

10. The method of claim 7, wherein
the representative values for each of the one or two category series of second grouped data are each calculated as an average value of the at least one category series of first grouped data.

11. The method of claim 10, wherein
the second drawing data is created as drawing data by which the representative values for each of the one or two category series of second grouped data are each displayed with a color determined based on an average value of colors that have been used for representing the at least one category series of first grouped data.

12. The method of claim 7, wherein
the creating the second drawing includes creating, upon detecting a return operation for returning the one or two category series of second grouped data to a state before the superimposing operation, drawing data by which the two or three category series of first grouped data before the superimposing operation are displayed on the screen.

13. An apparatus comprising:
a processor configured:
to, upon detecting, on a screen that displays first drawing including two or three category series of first grouped data each associated with different one of categories of the first grouped data, a superimposing operation for superimposing the two or three category series of first grouped data, calculate representative values for each of one or two category series of second grouped data that are generated by superimposing at least one category series of first grouped data in accordance with the superimposing operation,
to create second drawing data including the representative values that are calculated for each of the one or two category series of second grouped data, and
to display the second drawing data on the screen; and
a memory, coupled to the processor, configured to store the first and second drawing data.

14. The apparatus of claim 13, wherein,
when the first drawing data is displayed on the screen as a graph, the superimposing operation is defined as a shrinking operation for shrinking an axis displayed on the graph, the shrinking operation being performed by a first operation performed directly on the axis displayed on the graph or a second operation performed on an image that represents the axis and is displayed separately from the axis on the screen.

15. The apparatus of claim 13, wherein,
when the first drawing data is displayed on the screen as a graph, the superimposing operation is defined as a shrinking operation for shrinking an axis displayed on the graph, the shrinking operation being performed by a first operation performed directly on the axis displayed on the graph or a second operation performed on an image that represents the axis and is displayed separately from the axis on the screen.

16. The apparatus of claim 13, wherein
the representative values for each of the one or two category series of second grouped data are each calculated as an average value of the at least one category series of first grouped data.

17. The apparatus of claim 16, wherein
the second drawing data is created as drawing data by which the representative values for each of the one or two category series of second grouped data are each displayed with a color determined based on an average value of colors that have been used for representing the at least one category series of first grouped data.

18. The apparatus of claim 13, wherein
the processor is configured to create, upon detecting a return operation for returning the one or two category series of second grouped data to a state before the superimposing operation, drawing data by which the two or three category series of first grouped data before the superimposing operation are displayed on the screen.
